(19) United States
(12) Patent Application Publication
(10) Pub. No.: US 2020/0210646 A1
(43) Pub. Date: Jul. 2, 2020

(54) NATURAL LANGUAGE PROCESSING SHALLOW DISCOURSE PARSER

(71) Applicant: 3M INNOVATIVE PROPERTIES COMPANY, St. Paul, MN (US)

(72) Inventor: Jeremy R. Kornbluth, Cheverly, MD (US)

(21) Appl. No.: 16/727,176

(22) Filed: Dec. 26, 2019

Related U.S. Application Data
(60) Provisional application No. 62/786,633, filed on Dec. 31, 2018.

(51) Int. Cl. G06F 40/30; G06F 40/205; G06F 40/284; G06F 16/9032

(52) U.S. Cl. CPC G06F 40/30; G06F 16/90332; G06F 40/284; G06F 40/205

(57) ABSTRACT

The present disclosure provides an improved methodology for constructing and querying a shallow discourse stack. Multiple shallow discourse stacks may be generated and queried, such as using a separate discourse stack for each semantic type. In an example, various discourse stacks may be used for semantic types associated with clinical concept identification and medical code extraction from medical records. The use of a shallow discourse stack may include identifying a concept of a specific semantic type as needed to resolve an under-specified complex concept, and the shallow discourse stack may be queried using the specific semantic type to resolve the under-specified complex concept. The formation and querying of the shallow discourse stack may be repeated throughout the document until all complex concepts are resolved.

### CROSS REFERENCE TO RELATED APPLICATION

This application claims the benefit of U.S. Provisional Patent Application No. 62/786,633, filed Dec. 31, 2018, which is incorporated herein by reference in its entirety.

### BACKGROUND

Document text summarization generally includes a process of identifying and organizing topics. The topics may be determined based on a literal or semantic meaning of a group of words, sentences, paragraphs, chapters, or other grouping. Document text summarization may be performed for various purposes, such as for organizing information, indexing topics, inventorying, billing, and other purposes. The documents may be of different types for these purposes, such as medical records of procedures and services provided, academic and technical articles and papers, legal documents, and other document types.

Document text summarization is often performed manually, though there is an ongoing effort for automated text summarization (e.g., electronically processing documents). Because of these challenges, automated text summarization is typically rule-driven, inflexible, difficult to define and update, and generally expensive to maintain due to hardcoding within computer programs or components thereof. Further, the computer code and complexity of the rules are generally inaccessible to non-expert computer-coding employees.

While automated text summarization is a goal of computational discourse parsing, this computational discourse parsing provides a generalized extraction of discourse elements within the text. In some targeted uses, computational discourse parsing generally requires substantial computational complexity and generally provides insufficient detail for those targeted uses. What is needed is an improved solution for improving parsing and representing discourse elements for targeted uses.

### SUMMARY OF THE DISCLOSURE

The present disclosure provides an improved technical solution for various technical problems facing computational discourse parsing. As described herein, this technical solution includes an improved methodology for constructing and querying a shallow discourse stack for a targeted use. In an example, the shallow discourse stack may be applied for the targeted use of extracting complex clinical concepts from input texts, particularly when the information needed to identify the exact concept is not collocated within the document. Multiple shallow discourse stacks may be generated and queried, such as using a separate discourse stack for each semantic type. In an example, various discourse stacks may be used for semantic types associated with clinical concept identification and medical code extraction from medical records. For this and other targeted concept identification tasks, this technical solution provides a more efficient and more detailed output.

A set of recursive iterations may be used to form the shallow discourse stack. For example, the shallow discourse stack formation may include iterating over each region of the document, iterating within each region, iterating over each sentence, and iterating within each sentence over each identified concept. This iterative process builds a set of set of available entities (i.e., concepts) that are topical. As used herein, “topical” may be defined narrowly to include concepts that are available at any specific point in the document to add further specificity to an under-specified complex concept. For example, a medical procedure report dictated by a doctor may mention “pain” without referring to a body part or ambiguously referring to two or more body parts, and a topical body part may be used to identify the complete concept of “arm pain.” A human reading the dictation typically does not read every sentence in isolation, but instead builds up a mental model of the document so they are able to put together incomplete information from one part of the document with other incomplete information from another part of the document. The use of a shallow discourse stack improves on this process by identifying a concept of a specific semantic type as needed to resolve an under-specified complex concept, and the shallow discourse stack may be queried using the specific semantic type to resolve the under-specified complex concept. The formation and querying of the shallow discourse stack may be repeated throughout the document until all complex concepts are resolved.

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

### BRIEF DESCRIPTION OF THE FIGURES

The drawings illustrate generally, by way of example, but not by way of limitation, various embodiments discussed in the present document.

FIG. 1 is a block diagram of a document text summarization method, in accordance with various embodiments.

FIG. 2 is a block diagram of a shallow discourse stack method, in accordance with various embodiments.

FIG. 3 is a block diagram of a shallow discourse stack querying method, in accordance with various embodiments.

FIG. 4 is a block diagram of a computing device, according to an example embodiment.

### DETAILED DESCRIPTION

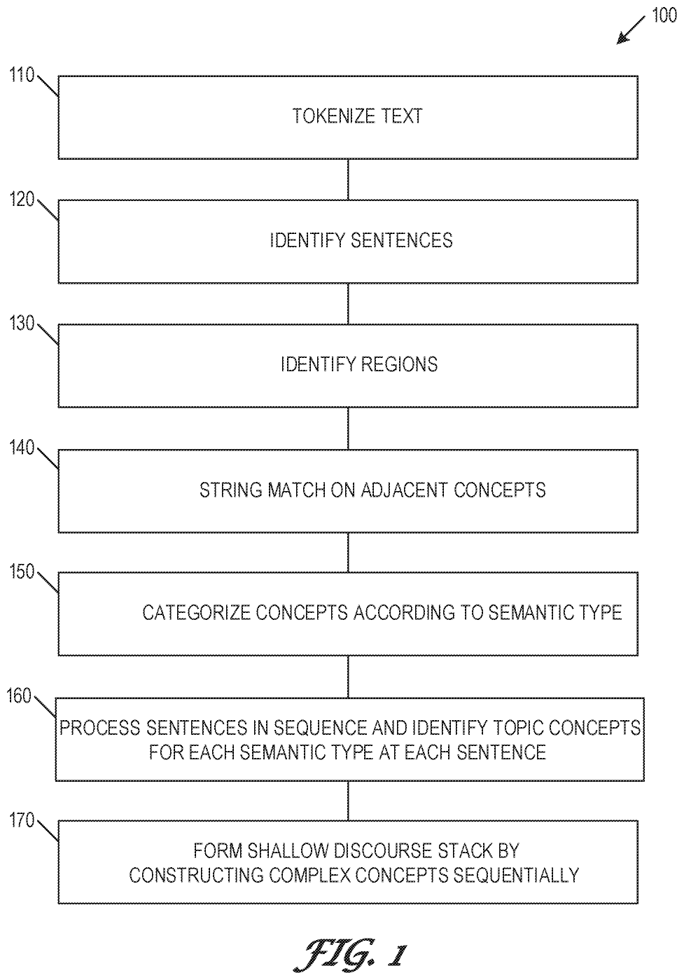

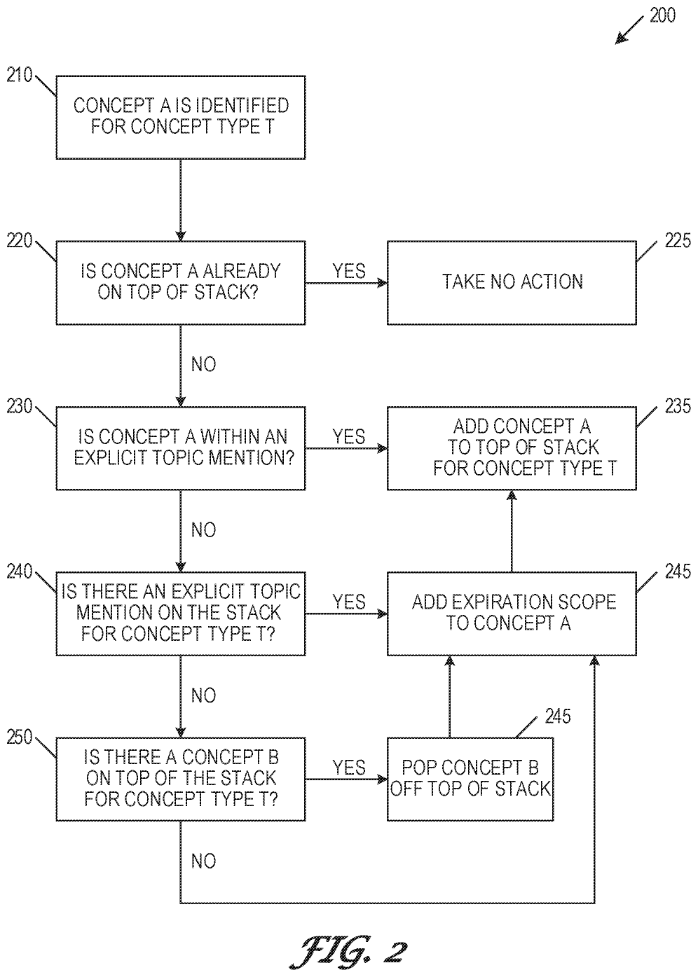

FIG. 1 is a block diagram of a document text summarization method 100, in accordance with various embodiments. Method 100 may be used for processing an input document to form a shallow discourse stack. Method 100 includes tokenizing 110 the input text. The tokenization 110 of input text may include splitting the text into multiple tokens, such as by splitting the document into phrases, individual words, or other tokens. The tokenization 110 may be specific to a use-case, such as specific to medical terminology. Method 100 includes identifying sentences 120 and identifying regions 130, where regions may include paragraphs, pages, chapters, or other groupings of sentences. Method 100 includes performing a string match 140 on atomic concepts (e.g., concepts that are adjacent in text or in close proximity). The string match may be used to resolve minor textual or terminological variations, such as matching “phalanges” with “fingers.” Method 100 includes categorizing concepts 150 according to semantic type. For example, a body part may be categorized 150 as a partonomic concept. Using the semantic types, method 100 includes processing sentences 160 in sequence, identifying topical concepts for each semantic type at each sentence. Using these topical concepts, method 100 includes forming 170 a shallow discourse stack for each complex concept, such as by constructing complex concepts sequentially. When missing or ambiguous concept is identified, the discourse stack may be queried to resolve the concept. The formation of the shallow discourse stack is described with respect to FIG. 2, below.

FIG. 2 is a block diagram of a shallow discourse stack method 200, in accordance with various embodiments. Method 200 may be used to generate or update a shallow discourse stack. Separate shallow discourse stacks may be used for each semantic type (e.g., for each concept type). For example, semantic types for medical document processing may include a body part, diagnosis, procedure, approach, laterality, or other medical semantic type. Method 200 may begin by identifying 210 concept “A” for concept type “T.” The shallow discourse stack may be examined to determine 220 whether concept “A” is already on top of the stack (e.g., the most recent entry in the shallow discourse stack). If concept “A” is already on top of the stack, then no action may be taken 225 to modify the shallow discourse stack.

When concept “A” is not already on top of the stack, then method 200 may include identifying 230 whether concept “A” is within an explicit topic mention, where an explicit topic mention is a concept that is explicitly topicalized by document structure. For example, a medical procedure report may include a title that identifies the examination, such as “Left Arm X-Ray Exam.” This use of explicit topic mentions takes advantage of the structure present in input document. If concept “A” is within an explicit topic mention, then concept “A” is added 235 to the top of the shallow discourse stack for concept type “T.” An explicit topic mention may be used for more than one shallow discourse stack. In the “Left Arm X-Ray Exam” example, “left arm” may be added to one shallow discourse stack and “x-ray” may be added to a different shallow discourse stack.

When concept “A” is not within an explicit topic mention, then method 200 may include identifying 240 whether there is an explicit topic mention on the stack for concept type “T.” If there is an explicit topic mention on the stack for concept type “T,” then an expiration scope is added 245 to concept “A,” and concept “A” is added 235 to the top of the shallow discourse stack for concept type “T.” The expiration scope may be used to define the scope (e.g., sentence, paragraph, region) of the explicit topic mention where topicality of this explicit topic mention expires. For example, a medical procedure description relating to an arm may include a single sentence discussion of a leg, and discussions of a body part outside of that single sentence expiration scope will relate to the arm. The expiration scope may be limited to when method 200 encounters and explicit topic mention or a new concept. When the expiration scope is reached, a topic is popped off of the shallow discourse stack (e.g., removed from the shallow discourse stack), and that topic is no longer available for reference. Because not every entity in a document is available for implicit reference at every point in the document, the construction of a set of topical entities will usually include removal of available entities by popping them off of the shallow discourse stack.

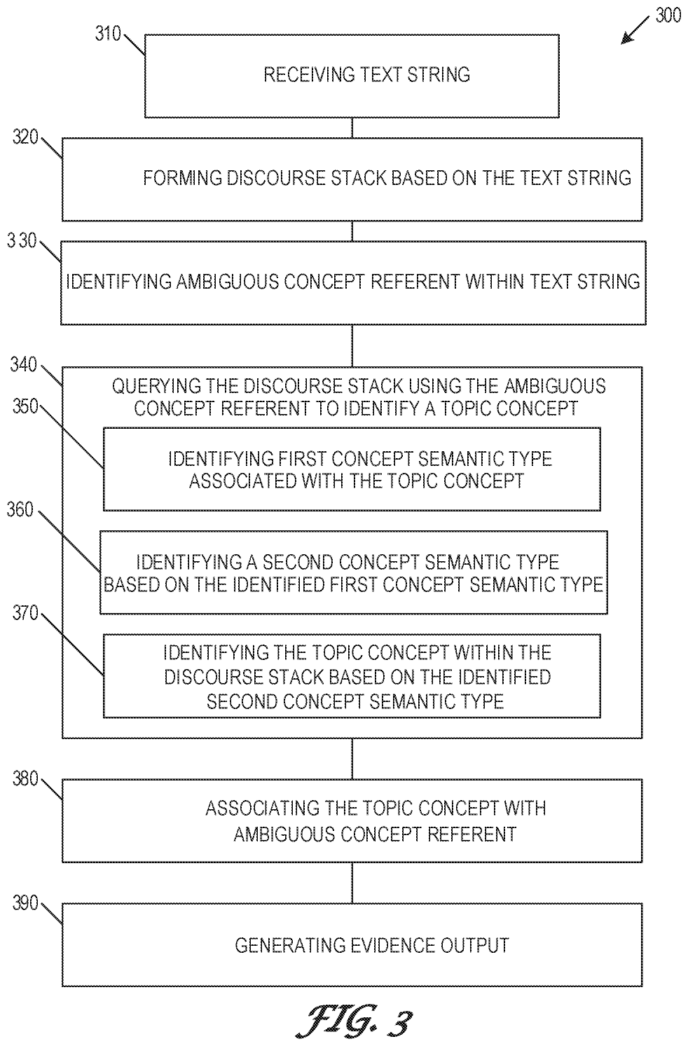

When there is no explicit topic mention on the stack for concept type “T,” then method 200 may include identifying 250 whether there is a concept “B” on top of the shallow discourse stack for concept type “T.” When there is a concept “B” on top of the shallow discourse stack for concept type “T,” then concept “B” is popped off 245 of the shallow discourse stack, an expiration scope is added 245 to concept “A,” and concept “A” is added 235 to the top of the shallow discourse stack for concept type “T.” For example, in a medical document discussion of an arm followed by a discussion of a leg, then subsequent discussion will be about the leg until there is an explicit topic mention of the arm. When there is no concept “B” on top of the shallow discourse stack for concept type “T,” then an expiration scope is added 245 to concept “A,” and concept “A” is added 235 to the top of the shallow discourse stack for concept type “T.” Method 200 may be repeated throughout the document for every identified concept and every semantic type to generate multiple shallow discourse stacks. The use and querying of the shallow discourse stacks is described with respect to FIG. 3, below.

FIG. 3 is a block diagram of a shallow discourse stack querying method 300, in accordance with various embodiments. When missing or ambiguous concept is identified, the discourse stack may be queried using querying method 300 to resolve the concept. Querying method 300 includes receiving 310 a text string, forming 320 a discourse stack based on the text string, and identifying 330 an ambiguous concept referent within the text string. The ambiguous concept referent may include an ambiguous reference to a previously mentioned concept. In an example of an ambiguous partonomic referent (e.g., body part referent), a document discussing a leg and an arm may include a description of an injury without specifying to which body part the injury pertains.

Querying method 300 includes querying 340 the discourse stack using the ambiguous concept referent to identify a topic concept. Querying method 300 may include identifying 350 a first concept semantic type associated with the topic concept and identifying 360 a second concept semantic type based on the identified first concept semantic type. The second concept semantic type may provide additional information about the first concept semantic type. For example, the first concept sematic type may include an injury description and the second concept semantic type may specify which body part is injured. Querying the discourse stack 340 includes identifying 370 the topic concept based on the identified second concept semantic type. In the injured body part example, identifying 370 the topic concept may include identifying which body part is injured. The first and second concept semantic type may include a closed set of terminology, such as a closed set of terminology for a predefined medical use case. The concept semantic type may include one or more of a body part, a body part laterality, a medical diagnosis, a medical procedure, or other concept semantic type. After querying the discourse stack 340, querying method 300 includes associating 380 the topic concept with the ambiguous concept referent. Querying method 300 may include generating 390 an evidence output, where the evidence output may include information about one or more of the ambiguous concept referent, the first and second concept semantic type, or other information used to resolve the ambiguous concept referent. The evidence output may be used to evaluate the certainty of the ambiguous concept referent resolution, such as by generating a resolution uncertainty factor.

The shallow discourse stack may be formed prior to querying the shallow discourse stack or in response to identifying 330 an ambiguous concept referent within the text string. As described above, the formation of the shallow discourse stack may include identifying a concept within the text string and adding the concept to a top stack position within the discourse stack. The concept may be selected from among a plurality of predefined relevant concepts. The formation of the discourse stack may further include identifying a topical entity within the text string and adding the topical entity to the top stack position within the discourse stack, where the topical entity adds specificity to the concept. In input text string may be received from a text document, where the text document may have an associated document structure. The text document may include an explicit topic mention, where the explicit topic mention includes one or more of a plurality of concepts explicitly topicalized by the associated document structure. The formation of the discourse stack may further include determining that the concept is associated with an explicit topic mention, and the concept may be added to the top of a discourse stack responsive to the determination that the concept is associated with the explicit topic mention. The formation of the discourse stack may further include determining that the discourse stack includes the explicit topic mention and associating the concept with a topic expiration scope, where the topic expiration scope defines a topic relevance region within the text document. The topic relevance region may include at least one of a document sentence, a document region, a document entirety, or other topic relevance region. The formation of the discourse stack may further include determining that the discourse stack includes a second concept with a second topic expiration scope on the stack top and removing the second concept from the top stack position within the discourse stack.

While the present disclosure includes examples of medical procedures and terminology, the shallow discourse stack formation and querying may be used in other contexts, such as academic and technical articles and papers, legal documents, and other document types. However, for each context, the semantic types are constrained to a finite and well-defined set of semantic types, where the semantic types are defined before formation or querying of the shallow discourse stack. The semantic types may be further constrained by the use case. For example, the semantic types may be constrained by clinical concepts, then further constrained by a use-driven subset of clinical concepts such as radiological diagnosis. The domain of the context language (e.g., legal text, clinical text, technical text) further constrains the domain. These constraints on the domain of semantic types and on the domain of context language further improve the performance and efficiency of the formation or querying of the shallow discourse stack. This is in contrast with deep-dive approaches such as deep discourse parsing, which is substantially more complex and computationally expensive. In further contrast with approaches like deep discourse parsing, the shallow discourse stack also provides information about the evidence that is used to resolve ambiguous terminology.

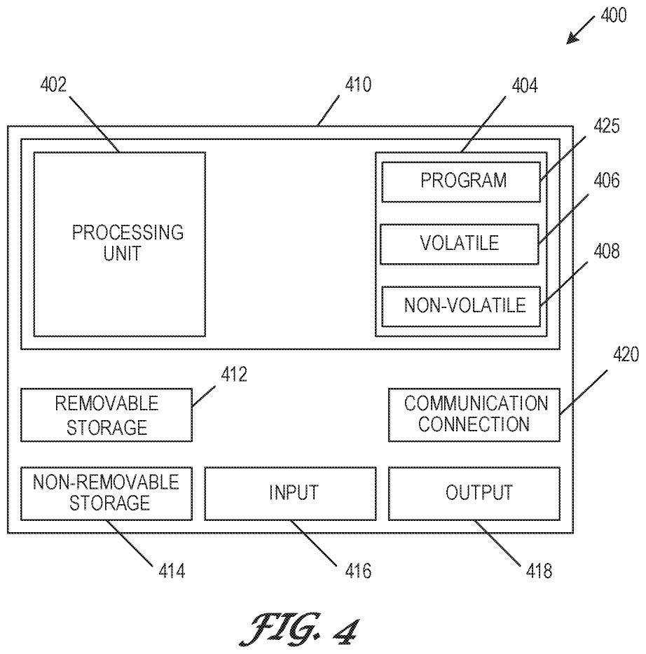

FIG. 4 is a block diagram of a computing device 400, according to an example embodiment. One example computing device 400 in the form of a computer 410, may include a processing unit 402, memory 404, removable storage 412, and non-removable storage 414. Although the example computing device 400 is illustrated and described as computer 410, the computing device 400 may be in different forms in different embodiments. For example, the computing device 400 may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet. In one embodiment, multiple such computer systems are utilized in a distributed network to implement multiple components in a transaction-based environment. An object-oriented, service-oriented, or other architecture may be used to implement such functions and communicate between the multiple systems and components.

Returning to the computer 410, memory 404 may include volatile memory 406 and non-volatile memory 408. Computer 410 may include or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM), electrically erasable programmable read-only memory (EEPROM), flash memory, compact disc read-only memory (CD ROM), Digital Versatile Disks (DVD) or other optical disk storage, magnetic cassettes, magnetic tape, magnetic disk storage or other magnetic storage devices, or any other memory technology or medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or other remote computer. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a Bluetooth® device that enables the computer 410 to wirelessly receive data from and transmit data to other Bluetooth® devices.

Computer-readable instructions stored on a computer-readable medium are executable by the processing unit 402 of the computer 410. A hard drive (e.g., magnetic disk, solid state drive), CD-ROM, and RAM are some examples of articles including a non-transitory computer-readable medium. For example, various computer programs 425 or apps, such as one or more applications and modules implementing one or more of the methods illustrated and described herein, including an app or application that executes on a mobile device or is accessible via a web browser, may be stored on a non-transitory computer-readable medium. For example, the computer programs 425 may include software of a natural language processing engine and software executable by the processing unit 402 to perform one or more of the methods 100, 200, and 300 of FIG. 1, FIG. 2, and FIG. 3, respectively.

Another system embodiments includes a computing device having at least one hardware processor and a natural language processor executable by the at least one hardware processor to process received input text and form and query a discourse stack. The computing device further includes at least one memory device storing a set of discourse stacks. The at least one memory device also stores instructions executable by the at least one hardware processor to perform data processing activities.

The data processing activities may include receiving input text of a new record and processing the received input text of the new record. The processing of the received input text of the new record is performed in part with the natural language processor to form or query a discourse stack. In some embodiments, the data processing activities further include matching an ambiguous concept referent with one or more concepts or concept types. The matching, in some embodiments, includes comparing newly processed text to one or more concepts or concept types. The data processing activities may also include storing, on the at least one memory device, a data representation of an identified topic concept with an ambiguous concept referent.

Various embodiments of the present disclosure can be better understood by reference to the following Examples which are offered by way of illustration. The present disclosure is not limited to the Examples given herein.

Example 1 is a computer-implemented natural language processing shallow discourse parser method, the method comprising: receiving a text string; forming a discourse stack based on the text string; identifying an ambiguous concept referent within the text string, the ambiguous concept referent referring ambiguously to a previously mentioned concept; querying the discourse stack using the ambiguous concept referent to identify a topic concept; and associating the topic concept with the ambiguous concept referent.

In Example 2, the subject matter of Example 1 optionally includes wherein: the topic concept includes a medical procedure topic; and the ambiguous concept referent includes an ambiguous partonomic referent, the ambiguous partonomic referent referring ambiguously to one or more body parts.

In Example 3, the subject matter of any one or more of Examples 1-2 optionally include identifying a first concept semantic type associated with the topic concept; and identifying a second concept semantic type based on the identified first concept semantic type, the second concept semantic type providing additional information about the first concept semantic type; wherein querying the discourse stack includes identifying topic concept based on the identified second concept semantic type.

In Example 4, the subject matter of Example 3 optionally includes wherein the first concept semantic type and the second concept semantic type include a closed set of terminology.

In Example 5, the subject matter of Example 4 optionally includes wherein the closed set of terminology includes a closed set of medical terminology.

In Example 6, the subject matter of Example 5 optionally includes wherein the closed set of medical terminology includes a closed set of terminology for a predefined medical use case.

In Example 7, the subject matter of Example 6 optionally includes wherein the concept semantic type includes one or more of a body part, a body part laterality, a medical diagnosis, and a medical procedure.

In Example 8, the subject matter of any one or more of Examples 1-7 optionally include wherein the formation of the discourse stack includes: identifying a concept within the text string, the concept among a plurality of predefined relevant concepts; and adding the concept to a top stack position within the discourse stack.

In Example 9, the subject matter of Example 8 optionally includes wherein the formation of the discourse stack further includes: identifying a topical entity within the text string, the topical entity adding specificity to the concept; and adding the topical entity to the top stack position within the discourse stack.

In Example 10, the subject matter of Example 9 optionally includes wherein: the text string is received from a text document, the text document having an associated document structure; and the text document includes an explicit topic mention, the explicit topic mention including a plurality of concepts explicitly topicalized by the associated document structure.

In Example 11, the subject matter of Example 10 optionally includes wherein: the formation of the discourse stack further includes determining that the concept is associated with an explicit topic mention; and the addition of the concept to the top of a discourse stack is responsive to the determination that the concept is associated with the explicit topic mention.

In Example 12, the subject matter of Example 11 optionally includes wherein the formation of the discourse stack further includes: determining that the discourse stack includes the explicit topic mention; and associating the concept with a topic expiration scope, the topic expiration scope defining a topic relevance region within the text document.

In Example 13, the subject matter of Example 12 optionally includes wherein the topic relevance region includes at least one of a document sentence, a document region, and a document entirety.

In Example 14, the subject matter of any one or more of Examples 12-13 optionally include wherein the formation of the discourse stack further includes: determining that the discourse stack includes a second concept with a second topic expiration scope on the stack top; and removing the second concept from the top stack position within the discourse stack.

Example 15 is one or more machine-readable medium including instructions, which when executed by a computing system, cause the computing system to perform any of the methods of Examples 1-14.

Example 16 is an apparatus comprising means for performing any of the methods of Examples 1-14.

Example 17 is a device comprising: a processor; and a memory device coupled to the processor and having a program stored thereon for execution by the processor to perform operation to perform a computer-implemented natural language processing shallow discourse parser method, the operations comprising: receiving a text string; forming a discourse stack based on the text string; identifying an ambiguous concept referent within the text string, the ambiguous concept referent referring ambiguously to a previously mentioned concept; querying the discourse stack using the ambiguous concept referent to identify a topic concept; and associating the topic concept with the ambiguous concept referent.

In Example 18, the subject matter of Example 17 optionally includes wherein: the topic concept includes a medical procedure topic; and the ambiguous concept referent includes an ambiguous partonomic referent, the ambiguous partonomic referent referring ambiguously to one or more body parts.

In Example 19, the subject matter of any one or more of Examples 17-18 optionally include the operations further including: identifying a first concept semantic type associated with the topic concept; and identifying a second concept semantic type based on the identified first concept semantic type, the second concept semantic type providing additional information about the first concept semantic type; wherein querying the discourse stack includes identifying topic concept based on the identified second concept semantic type.

In Example 20, the subject matter of Example 19 optionally includes wherein the first concept semantic type and the second concept semantic type include a closed set of terminology.

In Example 21, the subject matter of Example 20 optionally includes wherein the closed set of terminology includes a closed set of medical terminology.

In Example 22, the subject matter of Example 21 optionally includes wherein the closed set of medical terminology includes a closed set of terminology for a predefined medical use case.

In Example 23, the subject matter of Example 22 optionally includes wherein the concept semantic type includes one or more of a body part, a body part laterality, a medical diagnosis, and a medical procedure.

In Example 24, the subject matter of any one or more of Examples 17-23 optionally include wherein the formation of the discourse stack includes: identifying a concept within the text string, the concept among a plurality of predefined relevant concepts; and adding the concept to a top stack position within the discourse stack.

In Example 25, the subject matter of Example 24 optionally includes wherein the formation of the discourse stack further includes: identifying a topical entity within the text string, the topical entity adding specificity to the concept; and adding the topical entity to the top stack position within the discourse stack.

In Example 26, the subject matter of Example 25 optionally includes wherein: the text string is received from a text document, the text document having an associated document structure; and the text document includes an explicit topic mention, the explicit topic mention including a plurality of concepts explicitly topicalized by the associated document structure.

In Example 27, the subject matter of Example 26 optionally includes wherein: the formation of the discourse stack further includes determining that the concept is associated with an explicit topic mention; and the addition of the concept to the top of a discourse stack is responsive to the determination that the concept is associated with the explicit topic mention.

In Example 28, the subject matter of Example 27 optionally includes wherein the formation of the discourse stack further includes: determining that the discourse stack includes the explicit topic mention; and associating the concept with a topic expiration scope, the topic expiration scope defining a topic relevance region within the text document.

In Example 29, the subject matter of Example 28 optionally includes wherein the topic relevance region includes at least one of a document sentence, a document region, and a document entirety.

In Example 30, the subject matter of any one or more of Examples 28-29 optionally include wherein the formation of the discourse stack further includes: determining that the discourse stack includes a second concept with a second topic expiration scope on the stack top; and removing the second concept from the top stack position within the discourse stack.

Example 31 is a machine-readable storage device having instructions for execution by a processor of a machine to cause the processor to perform operations to perform a computer-implemented natural language processing shallow discourse parser method, the operations comprising: receiving a text string; forming a discourse stack based on the text string; identifying an ambiguous concept referent within the text string, the ambiguous concept referent referring ambiguously to a previously mentioned concept; querying the discourse stack using the ambiguous concept referent to identify a topic concept; and associating the topic concept with the ambiguous concept referent.

In Example 32, the subject matter of Example 31 optionally includes wherein: the topic concept includes a medical procedure topic; and the ambiguous concept referent includes an ambiguous partonomic referent, the ambiguous partonomic referent referring ambiguously to one or more body parts.

In Example 33, the subject matter of any one or more of Examples 31-32 optionally include identifying a first concept semantic type associated with the topic concept; and identifying a second concept semantic type based on the identified first concept semantic type, the second concept semantic type providing additional information about the first concept semantic type; wherein querying the discourse stack includes identifying topic concept based on the identified second concept semantic type.

In Example 34, the subject matter of Example 33 optionally includes wherein the first concept semantic type and the second concept semantic type include a closed set of terminology.

In Example 35, the subject matter of Example 34 optionally includes wherein the closed set of terminology includes a closed set of medical terminology.

In Example 36, the subject matter of Example 35 optionally includes wherein the closed set of medical terminology includes a closed set of terminology for a predefined medical use case.

In Example 37, the subject matter of Example 36 optionally includes wherein the concept semantic type includes one or more of a body part, a body part laterality, a medical diagnosis, and a medical procedure.

In Example 38, the subject matter of any one or more of Examples 31-37 optionally include wherein the formation of the discourse stack includes: identifying a concept within the text string, the concept among a plurality of predefined relevant concepts; and adding the concept to a top stack position within the discourse stack.

In Example 39, the subject matter of Example 38 optionally includes wherein the formation of the discourse stack further includes: identifying a topical entity within the text string, the topical entity adding specificity to the concept; and adding the topical entity to the top stack position within the discourse stack.

In Example 40, the subject matter of Example 39 optionally includes wherein: the text string is received from a text document, the text document having an associated document structure; and the text document includes an explicit topic mention, the explicit topic mention including a plurality of concepts explicitly topicalized by the associated document structure.

In Example 41, the subject matter of Example 40 optionally includes wherein: the formation of the discourse stack further includes determining that the concept is associated with an explicit topic mention; and the addition of the concept to the top of a discourse stack is responsive to the determination that the concept is associated with the explicit topic mention.

In Example 42, the subject matter of Example 41 optionally includes wherein the formation of the discourse stack further includes: determining that the discourse stack includes the explicit topic mention; and associating the concept with a topic expiration scope, the topic expiration scope defining a topic relevance region within the text document.

In Example 43, the subject matter of Example 42 optionally includes wherein the topic relevance region includes at least one of a document sentence, a document region, and a document entirety.

In Example 44, the subject matter of any one or more of Examples 42-43 optionally include wherein the formation of the discourse stack further includes: determining that the discourse stack includes a second concept with a second topic expiration scope on the stack top; and removing the second concept from the top stack position within the discourse stack.

Example 45 is an apparatus comprising: means for receiving a text string; means for forming a discourse stack based on the text string; means for identifying an ambiguous concept referent within the text string, the ambiguous concept referent referring ambiguously to a previously mentioned concept; means for querying the discourse stack using the ambiguous concept referent to identify a topic concept; and means for associating the topic concept with the ambiguous concept referent.

In Example 46, the subject matter of Example 45 optionally includes wherein: the topic concept includes a medical procedure topic; and the ambiguous concept referent includes an ambiguous partonomic referent, the ambiguous partonomic referent referring ambiguously to one or more body parts.

In Example 47, the subject matter of any one or more of Examples 45-46 optionally include means for identifying a first concept semantic type associated with the topic concept; and means for identifying a second concept semantic type based on the identified first concept semantic type, the second concept semantic type providing additional information about the first concept semantic type; wherein means for querying the discourse stack includes identifying topic concept based on the identified second concept semantic type.

In Example 48, the subject matter of Example 47 optionally includes wherein the first concept semantic type and the second concept semantic type include a closed set of terminology.

In Example 49, the subject matter of Example 48 optionally includes wherein the closed set of terminology includes a closed set of medical terminology.

In Example 50, the subject matter of Example 49 optionally includes wherein the closed set of medical terminology includes a closed set of terminology for a predefined medical use case.

In Example 51, the subject matter of Example 50 optionally includes wherein the concept semantic type includes one or more of a body part, a body part laterality, a medical diagnosis, and a medical procedure.

In Example 52, the subject matter of any one or more of Examples 45-51 optionally include wherein the means for formation of the discourse stack includes: means for identifying a concept within the text string, the concept among a plurality of predefined relevant concepts; and means for adding the concept to a top stack position within the discourse stack.

In Example 53, the subject matter of Example 52 optionally includes wherein the means for formation of the discourse stack further includes: means for identifying a topical entity within the text string, the topical entity adding specificity to the concept; and means for adding the topical entity to the top stack position within the discourse stack.

In Example 54, the subject matter of Example 53 optionally includes wherein: the text string is received from a text document, the text document having an associated document structure; and the text document includes an explicit topic mention, the explicit topic mention including a plurality of concepts explicitly topicalized by the associated document structure.

In Example 55, the subject matter of Example 54 optionally includes wherein: the means for formation of the discourse stack further includes means for determining that the concept is associated with an explicit topic mention; and the means for addition of the concept to the top of a discourse stack is responsive to the determination that the concept is associated with the explicit topic mention.

In Example 56, the subject matter of Example 55 optionally includes wherein the means for formation of the discourse stack further includes: means for determining that the discourse stack includes the explicit topic mention; and means for associating the concept with a topic expiration scope, the topic expiration scope defining a topic relevance region within the text document.

In Example 57, the subject matter of Example 56 optionally includes wherein the topic relevance region includes at least one of a document sentence, a document region, and a document entirety.

In Example 58, the subject matter of any one or more of Examples 56-57 optionally include wherein the means for formation of the discourse stack further includes: means for determining that the discourse stack includes a second concept with a second topic expiration scope on the stack top; and means for removing the second concept from the top stack position within the discourse stack.

Example 59 is one or more machine-readable medium including instructions, which when executed by a machine, cause the machine to perform operations of any of the operations of Examples 1-58.

Example 60 is an apparatus comprising means for performing any of the operations of Examples 1-58.

Example 61 is a system to perform the operations of any of the Examples 1-58.

Example 62 is a method to perform the operations of any of the Examples 1-58.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

What is claimed is:

1. A computer-implemented natural language processing shallow discourse parser method, the method comprising:
receiving a text string;
forming a discourse stack based on the text string;
identifying an ambiguous concept referent within the text string, the ambiguous concept referent referring ambiguously to a previously mentioned concept;
querying the discourse stack using the ambiguous concept referent to identify a topic concept; and
associating the topic concept with the ambiguous concept referent.

2. The method of claim 1, wherein:
the topic concept includes a medical procedure topic; and
the ambiguous concept referent includes an ambiguous partonomic referent, the ambiguous partonomic referent referring ambiguously to one or more body parts.

3. The method of claim 1, further including:
identifying a first concept semantic type associated with the topic concept; and
identifying a second concept semantic type based on the identified first concept semantic type, the second concept semantic type providing additional information about the first concept semantic type;
wherein querying the discourse stack includes identifying topic concept based on the identified second concept semantic type.

4. The method of claim 3, wherein the first concept semantic type and the second concept semantic type include a closed set of terminology.

5. The method of claim 1, wherein the formation of the discourse stack includes:
identifying a concept within the text string, the concept among a plurality of predefined relevant concepts; and
adding the concept to a top stack position within the discourse stack.

6. The method of claim 5, wherein the formation of the discourse stack further includes:
identifying a topical entity within the text string, the topical entity adding specificity to the concept; and
adding the topical entity to the top stack position within the discourse stack.

7. The method of claim 6, wherein:
the text string is received from a text document, the text document having an associated document structure; and
the text document includes an explicit topic mention, the explicit topic mention including a plurality of concepts explicitly topicalized by the associated document structure.

8. The method of claim 7, wherein:
the formation of the discourse stack further includes determining that the concept is associated with an explicit topic mention; and
the addition of the concept to the top of a discourse stack is responsive to the determination that the concept is associated with the explicit topic mention.

9. The method of claim 8, wherein the formation of the discourse stack further includes:
determining that the discourse stack includes the explicit topic mention; and
associating the concept with a topic expiration scope, the topic expiration scope defining a topic relevance region within the text document.

10. The method of claim 9, wherein the topic relevance region includes at least one of a document sentence, a document region, and a document entirety.

11. The method of claim 9, wherein the formation of the discourse stack further includes:
determining that the discourse stack includes a second concept with a second topic expiration scope on the stack top; and
removing the second concept from the top stack position within the discourse stack.

12. A device comprising:
a processor; and
a memory device coupled to the processor and having a program stored thereon for execution by the processor to perform operation to perform a computer-implemented natural language processing shallow discourse parser method, the operations comprising:
receiving a text string;
forming a discourse stack based on the text string;
identifying an ambiguous concept referent within the text string, the ambiguous concept referent referring ambiguously to a previously mentioned concept;
querying the discourse stack using the ambiguous concept referent to identify a topic concept; and
associating the topic concept with the ambiguous concept referent.

13. The device of claim 12, the operations further including:
identifying a first concept semantic type associated with the topic concept; and
identifying a second concept semantic type based on the identified first concept semantic type, the second concept semantic type providing additional information about the first concept semantic type;
wherein querying the discourse stack includes identifying topic concept based on the identified second concept semantic type.

14. The device of claim 13, wherein the first concept semantic type and the second concept semantic type include a closed set of terminology.

15. A machine-readable storage device having instructions for execution by a processor of a machine to cause the processor to perform operations to perform a computer-implemented natural language processing shallow discourse parser method, the operations comprising:
receiving a text string;
forming a discourse stack based on the text string;
identifying an ambiguous concept referent within the text string, the ambiguous concept referent referring ambiguously to a previously mentioned concept;
querying the discourse stack using the ambiguous concept referent to identify a topic concept; and
associating the topic concept with the ambiguous concept referent.

16. The device of claim 15, the operations further including:
identifying a first concept semantic type associated with the topic concept; and
identifying a second concept semantic type based on the identified first concept semantic type, the second concept semantic type providing additional information about the first concept semantic type;
wherein querying the discourse stack includes identifying topic concept based on the identified second concept semantic type.

17. The device of claim 16, wherein the first concept semantic type and the second concept semantic type include a closed set of terminology.

18. The device of claim 15, wherein the formation of the discourse stack includes:
identifying a concept within the text string, the concept among a plurality of predefined relevant concepts; and
adding the concept to a top stack position within the discourse stack.

19. The device of claim 18, wherein the formation of the discourse stack further includes:
identifying a topical entity within the text string, the topical entity adding specificity to the concept; and
adding the topical entity to the top stack position within the discourse stack.

20. The device of claim 19, wherein:
the text string is received from a text document, the text document having an associated document structure; and
the text document includes an explicit topic mention, the explicit topic mention including a plurality of concepts explicitly topicalized by the associated document structure.
